(19) United States
(12) Patent Application Publication
(10) Pub. No.: US 2026/0300442 A1
(43) Pub. Date: Oct. 1, 2026

(54) Parameter-Free Derivation of Physical Constants and Characteristic Scales Using Recognition Science

(71) Applicant: Jonathan Washburn, Austin, TX (US)

(72) Inventor: Jonathan Washburn, Austin, TX (US)

(21) Appl. No.: 19/630,070

(22) Filed: Mar. 26, 2026

Related U.S. Application Data
(60) Provisional application No. 63/778,917, filed on Mar. 27, 2025.

(51) Int. Cl. G06F 18/2415; G06F 17/13

(52) U.S. Cl. CPC G06F 18/2415; G06F 17/13

(57) ABSTRACT

A computer-implemented method and computing system derive physical constants and characteristic scales using Recognition Science and Recognition Physics constructs. A target specification identifying a constant or scale is received and classified. A recognition system representation is defined and a construct family is selected from cost-functional, operator/spectrum, and scale-cascade families. A construct is instantiated using Recognition Science/Recognition Physics quantities and is solved without using a target-specific empirical value of the target constant or scale. A derived value is extracted from the computed solution and a derivation trace is generated that records the construct family, construct definition payload, quantities used, solver settings, and the derived value. A calibration seam may be applied after extraction to map Recognition Science/Recognition Physics native quantities to reporting units while enforcing a no-target-specific-fitting constraint, and optional validation metrics and decision outcomes may be recorded.

### CROSS-REFERENCE TO RELATED APPLICATIONS

This application claims benefit of priority to U.S. Provisional Patent Application No. 63/778,917, titled “Method for Deriving Physical Constants and Scales Based on Recognition Physics Principles” filed on Mar. 27, 2025.

### BACKGROUND

The present disclosure relates to computational methods and computing systems for deriving physical constants and characteristic scales using Recognition Science (RS) and Recognition Physics (RP) constructs. More particularly, the disclosure relates to parameter-free derivation workflows that compute dimensionless couplings, characteristic lengths, characteristic energies, and mass scales by selecting and solving internally specified RS/RP constructs, and by optionally reporting derived outputs in conventional units through an explicit calibration seam.

In many conventional physics and computational modeling approaches, key constants and scale-setting quantities are treated as empirically measured inputs, and model performance is often improved by fitting parameters to match observed values. While such approaches can be effective for prediction within calibrated regimes, they do not provide a general-purpose, auditable method for deriving constants and characteristic scales from a unified internal framework without target-specific empirical tuning. As a result, there remains a need for computational derivation techniques that define and solve construct families in a manner that is reproducible and traceable, that can be applied across multiple target classes (including dimensionless couplings, length scales, energy scales, and mass scales), and that provides explicit separation between parameter-free derivation and any unit-reporting conventions used to express results in standard reporting units.

### SUMMARY

The present disclosure provides methods and computing systems for deriving physical constants and characteristic scales using Recognition Science (RS) and Recognition Physics (RP) constructs. A target specification identifying a physical constant or characteristic scale is received and classified, an RS/RP system representation is defined for the target, and a construct family is selected from among multiple disclosed construct families. The selected construct is instantiated using RS/RP quantities and solved without using a target-specific empirical value of the target constant or scale. A derived value is extracted from the computed solution and a derivation trace is generated that records the selected construct family, the construct definition payload, RS/RP quantities used, solver settings, intermediate values, and the derived output. In this manner, the disclosure provides a parameter-free derivation workflow that is reproducible and auditable. Where reporting in conventional units is desired, an explicit calibration seam is applied after extraction to map RS-native quantities to reporting units without modifying the construct definition or solution, thereby maintaining a no-target-specific-fitting constraint while supporting consistent reporting conventions.

In one embodiment, a cost-functional construct family is used to determine an optimal recognition scale by minimizing an explicitly defined coverage-based cost functional over a continuous domain. The cost functional penalizes deviations from a self-similarity target and the derived output is defined as the minimizer of the functional under specified numerical computation controls, such as convergence tolerance and integration window truncation. In another embodiment, a universal scale cascade construct family computes characteristic length or energy scales using a cascade relation that maps an index to a derived output via a universal scale factor and a declared anchor convention, where the index is selected according to a minimal overhead selection criterion associated with the RS/RP system representation. In further embodiments, an operator or spectrum construct family defines an operator-based recognition construct and derives a target output from a spectral quantity obtained by solving an eigenvalue problem under disclosed boundary and domain constraints. These embodiments may be implemented in a computing system that includes modules for system definition, construct formulation, construct solving, extraction, optional validation, and derivation trace generation, enabling automated derivation of constants and scales with traceable computation artifacts.

### BRIEF DESCRIPTION OF THE DRAWINGS

The various advantages of the examples will become apparent to one skilled in the art by reading the following specification and appended claims, and by referencing the following drawings, in which:

FIG. 1 is a flow diagram illustrating an overall Recognition Physics and Recognition Science derivation workflow that receives a target constant or characteristic scale specification, defines a corresponding recognition system representation, selects a construct family, solves an instantiated construct, extracts a derived value, and produces a derivation trace.

FIG. 2 is a block diagram illustrating an example computing system architecture for implementing the derivation workflow, including client and server components, network communication, and functional modules for system definition, construct formulation, solving, extraction, optional validation, and trace generation, together with optional storage and service interfaces.

FIG. 3 is a conceptual diagram illustrating a Recognition Science and Recognition Physics foundation map, including cost-first primitives, self-similarity forcing, discrete cadence structure, and internal identities used as a basis for construct formulation and derivation.

FIG. 4 is a flow diagram illustrating a cost-functional derivation pathway, including definition of a coverage function, definition of a self-similarity target, construction of a cost functional, minimization of the cost functional, and output of an optimal recognition scale, together with example numerical integration and convergence controls.

FIG. 5 is a flow diagram illustrating a universal scale cascade derivation pathway, including definition of length and energy cascade relations, selection of an anchor convention, selection of a cascade index according to a disclosed criterion, computation of cascade outputs, and optional positivity and monotonicity checks.

FIG. 6 is a flow diagram illustrating an operator or spectrum derivation pathway, including construction of an operator, selection of a potential, specification of domain and boundary conditions, solution of an eigenvalue problem, extraction of a spectral quantity, and mapping of the extracted quantity to a derived scale or mass, optionally with modulation factors.

FIG. 7 is a diagram illustrating an example derivation trace report format that records target information, construct selection, construct definition, constants used, solver settings, intermediate results, a final derived value, and optional validation metrics and decision outcomes.

FIG. 8 is a diagram illustrating a calibration seam and unit reporting pathway that maps Recognition Science and Recognition Physics native quantities to reporting-unit outputs using declared anchor parameters and a mapping function while enforcing a no-target-specific-fitting constraint, and optionally performing cross-output consistency checks.

FIG. 9 is a flow diagram illustrating example fine-structure derivation components, including selection among alternative embodiments, computation using a functional minimization embodiment or a closed-form embodiment, combination of terms to produce an output coupling value, and optional validation against a reference.

### DETAILED DESCRIPTION

Definitions and Notation are provided to ensure that the terms used throughout this disclosure have explicit meaning, objective boundaries, and consistent interpretation across the method embodiments, system embodiments, and computational implementations. The term “Recognition” refers to an interaction, mapping, or process whose stability, value, or selection is determined by an optimization of a recognition cost under Recognition Science (RS) and/or Recognition Physics (RP). In this sense, a recognition process may be represented as an input-output mapping, an evolution rule, an operator action on a state, or a multi-scale transformation whose permissible outcomes are selected by minimizing or otherwise optimizing a cost measure defined by RS/RP constructs. “Recognition cost” and “J-cost” refer to a cost assigned to recognition transitions, configurations, or scale transforms; in RS embodiments disclosed herein, a unique cost form is used, namely J(x)=0.5*(x+1/x)−1 for x>0, where x is a positive scalar recognition ratio or scale ratio. The Recognition Composition Law (RCL) is a primitive composition identity governing the behavior of the cost under multiplicative composition and division, and is defined as J(x*y)+J(x/y)=2*J(x)*J(y)+2*J(x)+2*J(y), which is used to justify the admissible construction of compound costs and to enforce the internal consistency of the cost framework.

As used herein, “Minimal Overhead” refers to a selection criterion that selects among candidate construct solutions by minimizing a computed overhead score, including (as applicable) selecting a discrete integer index, selecting among multiple candidate construct families, selecting among multiple admissible boundary conditions, or selecting among multiple stable solutions of an optimization problem. In embodiments, the overhead score is computed from objective, machine-evaluated components such as: (i) a feasibility indicator (e.g., whether the candidate satisfies disclosed constraints and boundary conditions), (ii) a convergence indicator (e.g., whether a solver meets a disclosed convergence criterion within a disclosed maximum iteration count), and (iii) a runtime or complexity indicator (e.g., iteration count, discretization size, or evaluated cost-functional value). Minimal Overhead may be implemented as a direct minimization over a defined cost functional, as a ranking over a finite set of candidates, or as an internal decision rule that selects the candidate with the smallest computed overhead score subject to feasibility constraints, convergence constraints, and system-class constraints. When multiple candidates have equal or indistinguishably close overhead scores within a declared tie tolerance, a deterministic tie-break rule is applied, such as selecting the candidate with (a) fewer solver iterations, then (b) smaller discretization size or index magnitude, and then (c) a declared canonical ordering of candidates. “Parameter-free derivation” refers to a derivation process in which no empirically measured values specific to a target constant enter the steps that define the target system, formulate the RS/RP construct, and solve the construct. In a parameter-free derivation, the construct formulation and solution are performed using RS/RP axioms and derived relationships, including dimensionless constants and internal RS/RP quantities; numerical reporting in conventional units is permitted only through an explicitly declared calibration seam, and such reporting is not treated as a fit parameter. A “Calibration seam” (also referred to as an “external calibration anchor”) refers to an explicitly declared mapping from RS-native units or RS-native quantities to reporting units (including SI and electron-volts), where the mapping is applied consistently across targets and is not tuned per target. A calibration seam may be implemented using a single declared anchor parameter (for example, a declared mapping of a fundamental tick to seconds), or using a defined anchor set (for example, an anchoring convention that maps RS-native scales to standard physical unit systems) provided that the convention is declared as a reporting mapping and not as target-specific empirical tuning.

“Derivation trace” refers to a machine-readable record of a derivation pathway, including the selected construct family, the specific construct definition used (including equations and constants), solver settings, intermediate values, the extracted final value, and (when enabled) validation metrics and decision outcomes. The derivation trace is intended to allow reproducibility, auditability, and post hoc verification of the derivation without reintroducing empirical fitting at the point of derivation.

The following symbols and notation are used throughout this disclosure, and each symbol is intended to be ASCII-safe for inclusion in plain-text environments. phi denotes the golden ratio, defined as the unique positive solution to phi\hat{ }2=phi+1. pi denotes the circle constant. X_opt denotes an optimal recognition scale; in some embodiments X_opt=phi/pi. R_RP denotes a Recognition Physics resonance index; in some embodiments R_RP= 7/12. eta_RP denotes a Recognition Physics fermion efficiency; in some embodiments eta_RP=sqrt(⅝). J(x) denotes the RS cost function described above. J_cov(X) denotes a coverage cost functional that depends on a scale parameter X and is used in embodiments to determine X_opt. H_hat denotes a self-adjoint operator embodiment used in spectrum-based derivations. R_hat denotes a recognition operator embodiment used in discrete recognition evolution embodiments. r_n and E_n denote cascade values, where r_n is a length-scale output and E_n is an energy-scale output indexed by an index n, which may be an integer in certain embodiments. L_anchor and E_anchor denote chosen anchor scales used for cascade computations, where the selection of anchors is disclosed as part of a declared reporting scheme or calibration seam rather than target-specific fitting. tau0 denotes an RS-native fundamental tick associated with an eight-tick cadence in disclosed embodiments. ell0 denotes an RS-native spatial step. c denotes a derived speed relation expressed in RS-native terms as c=ell0/tau0. E_coh denotes a coherence quantum; in some embodiments E_coh=phi\hat{ }(−5) in RS-native form. hbar denotes the reduced Planck constant; in RS-native embodiments an identity hbar=E_coh*tau0 is used as an internal relation. lambda_rec denotes a recognition length scale that appears in a disclosed Planck-gate identity. G denotes a gravitational constant derived in embodiments from a Planck-gate identity using RS-native relations and a declared seam. alpha and alpha_inv denote the electromagnetic coupling and its inverse, respectively, where alpha_inv may be expressed in closed-form using disclosed RS/RP terms in certain embodiments.

Recognition Science (RS) is used herein as a cost-first framework in which stable physical quantities, characteristic scales, and computable invariants arise as solutions of cost-minimization constraints. In this disclosure, RS is treated as a specification-level foundation that provides (i) a primitive cost-composition rule, (ii) a uniquely determined cost function over positive ratios, and (iii) a forcing chain that yields self-similar constants and time/scale structure without target-specific empirical fitting. Recognition Physics (RP) refers to embodiments in which the RS framework is applied specifically to derive physical constants and characteristic scales and to construct parameter-free computational pathways for doing so.

A primitive element of RS used in this disclosure is the Recognition Composition Law (RCL), which constrains how recognition costs behave under multiplicative composition and division of positive scalar ratios. The RCL is defined as J(x*y)+J(x/y)=2*J(x)*J(y)+2*J(x)+2*J(y), where x>0 and y>0. The RCL supports building compound costs and enforces internal consistency of cost aggregation across multi-step recognition processes. Under RS assumptions referenced by this disclosure, the cost function consistent with the RCL is uniquely determined (up to normalization and calibration conventions) as J(x)=0.5*(x+1/x)−1 for x>0. This cost form is reciprocal, meaning J(x)=J(1/x), and is strictly convex over x>0, which implies uniqueness of minima for optimization problems constructed from J or from cost functionals derived from J. These properties are used to justify that certain optimization-defined outputs (including optimal scales and stable solutions) are well-defined and reproducible in the disclosed derivation methods.

Self-similarity constraints operating under the cost structure force the appearance of the golden ratio phi as a distinguished positive scale value. In particular, a self-similarity relationship of the form x=1+1/x implies x\hat{ }=x+1, whose unique positive solution is x=phi. In disclosed embodiments, phi acts as a fixed point for scale self-similarity and enters derived constants and identities either directly (through closed-form expressions) or indirectly (through derived optimal recognition scales).

RS further provides a discrete cadence structure referred to herein as “eight-tick,” where a minimal period may be expressed as 2\hat{ }D and, in embodiments relevant to this disclosure, D=3 yields a period of 8. This eight-tick structure is used to define a fundamental RS-native tick tau0, where tau0 is the time step associated with one tick of the eight-tick cadence. In some embodiments, tau0 may be expressed in RS-native form using a relationship of the form tau0~1/(8*ln(phi)); where such a relationship is included, it is treated as an RS-native timescale definition and is used as part of the disclosed derivation chain only when explicitly invoked in the implementation steps for a target constant or scale.

From the RS forcing chain, the disclosure employs a set of RS-native relations that connect a fundamental time tick, a spatial step, and derived physical constants. A speed relation is expressed in RS-native terms as c=ell0/tau0, where ell0 is an RS-native spatial step and tau0 is the RS-native tick. A coherence quantum is expressed in RS-native form as E_coh=phi\hat{ }(−5). An IR-gate identity relates action to coherence and time as hbar=E_coh*tau0. A Planck-gate identity connects a recognition length scale to gravitation through (c\hat{ }*lambda_rec\hat{ }2)/(hbar*G)=1/pi, where lambda_rec is a recognition length scale and G is a gravitational constant derived in embodiments from the identity together with other RS-native relations and a declared unit-mapping convention. In this disclosure, these relations are treated as internal RS/RP structural identities. When numerical reporting is performed in SI or other conventional units, that reporting is carried out through an explicit calibration seam, and the disclosure treats the seam as a reporting mapping rather than as a target-specific fit.

RP embodiments of this disclosure further use a set of RP universal constants that are treated as derived, not empirically fitted, and that can function as universal factors or modulators within disclosed derivation pathways. In embodiments, an optimal recognition scale is X_opt=phi/pi.

A resonance/stability index is R_RP= 7/12, associated with a three-dimensional dual-recognition stability constraint in RP embodiments. A fermion efficiency factor is eta_RP=sqrt(⅝), associated with two-point recognition geometry in RP embodiments. These RP constants may appear as direct outputs of RS/RP minimization (for example, as the minimizer of a disclosed cost functional) and/or as fixed factors in operator-based derivations, cascade-based derivations, coupling derivations, or modulation of extracted quantities. The constants are introduced here as foundational quantities that are reused across the later construct families (cost functional, operator/spectrum, and scale cascade) and across example embodiments, while maintaining the parameter-free constraint that excludes target-specific empirical tuning in the construct definition and solution steps.

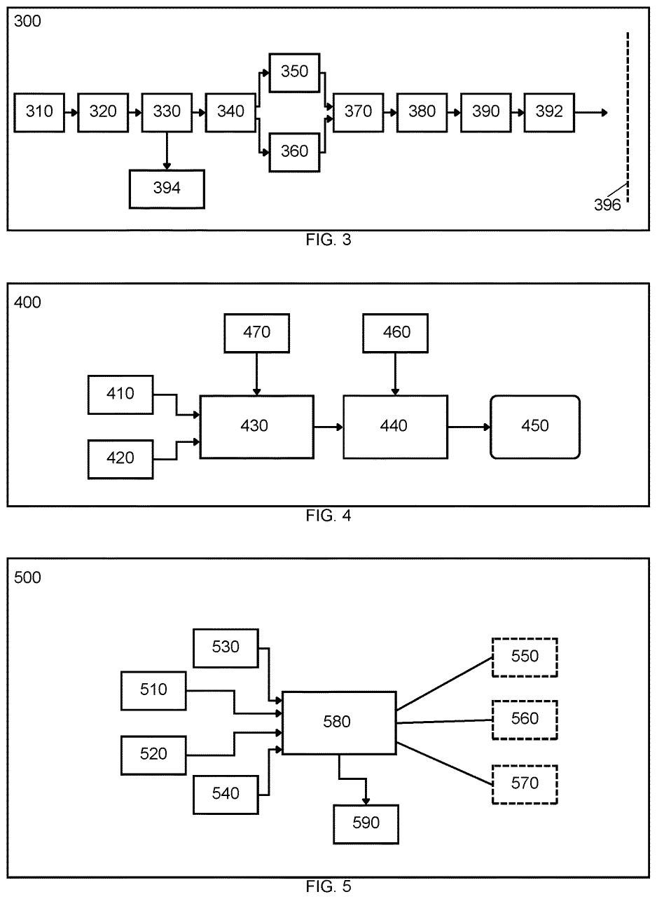

FIG. 3 illustrates an RS/RP foundation map (300) in which a Recognition Composition Law (RCL) primitive (310) constrains admissible cost constructions, a unique RS cost function J(x) is specified (320), and a self-similarity forcing yields the golden ratio phi (330). FIG. 3 further illustrates an eight-tick cadence constraint (340) that defines a fundamental tick tau0 (350) and an RS-native spatial step ell0 (360), which together define an RS-native speed relation c=ell0/tau0 (370). FIG. 3 also illustrates an RS-native coherence quantum E_coh (380), an IR-gate action identity hbar=E_coh*tau0 (390), and a Planck-gate/gravity identity connecting c, lambda_rec, hbar, and G (392). FIG. 3 additionally depicts an RP universal constants set (394) and an explicit calibration seam boundary between RS-native derivation quantities and reporting-unit mapping (396).

FIG. 3 depicts an RS/RP foundation map (300) in which admissible construct formation is constrained by an RCL primitive (310) and a specified RS cost function J(x) (320), with self-similarity forcing yielding the golden ratio phi (330) and an eight-tick cadence constraint (340) defining tau0 (350) and ell0 (360) used to express c=ell0/tau0 (370), together with an RS-native coherence quantum Ecoh (380), an action identity hbar=Ecoh*tau0 (390), a Planck-gate/gravity identity linking c, lambda_rec, hbar, and G (392), an RP universal constants set (394), and an explicit calibration seam boundary (396) between RS-native derivation quantities and reporting-unit mapping.

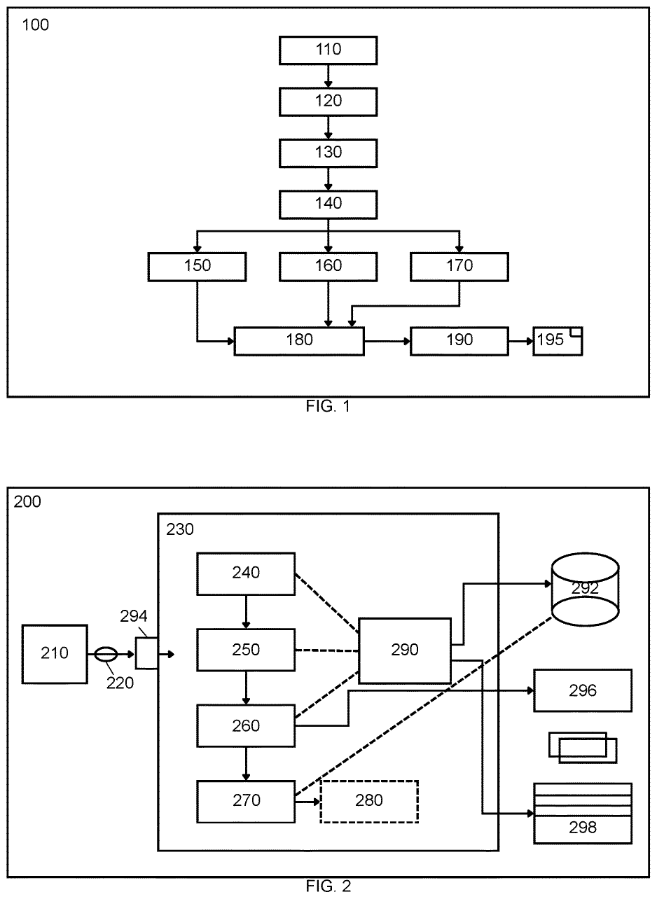

The derivation methods disclosed herein compute physical constants and characteristic scales by executing a four-step derivation workflow that begins with a target specification and proceeds through construct selection, parameter-free solution, and extraction of a derived value. FIG. 1 illustrates an overall Recognition Physics (RP) derivation workflow (100) including input of a target constant or scale specification (110), target classification (120), system definition (130), construct selection (140), construct-family branch paths (150), (160), (170), solution (180), extraction (190), and derivation trace output (195). The four-step workflow is implemented such that the construct definition and solution rely on RS/RP axioms, RS/RP forcing constants, and disclosed internal identities, while excluding target-specific empirical fitting, and optionally applying a declared calibration seam only at a reporting stage as described elsewhere herein.

FIG. 1 depicts an example end-to-end derivation workflow (100) in which a target specification is received (110), classified (120), and used to generate a system definition (130) that constrains admissible constructs; a construct family is selected (140) from branch paths including cost-functional (150), operator/spectrum (160), and scale-cascade (170); the selected construct is instantiated and solved without target-specific empirical fitting (180); a derived value is extracted according to a disclosed extraction rule (190); and a derivation trace/report artifact is generated and output (195) to preserve reproducibility and auditability of the computation.

The cost-functional, operator/spectrum, and scale-cascade construct families disclosed herein are alternative implementations (species) of a single derivation engine that applies the same four-step workflow: (i) receiving and classifying a target specification, (ii) defining a recognition system representation that constrains admissible solutions, (iii) instantiating a construct using RS/RP-defined quantities while excluding target-specific empirical fitting, and (iv) solving the construct and extracting a derived output. Across all construct families, the derivation output is generated together with a derivation trace artifact that records at least the selected construct family, construct definition payload, constants used, solver settings, and the derived value, and any optional reporting-unit conversion is performed only via a declared calibration seam applied after the parameter-free derivation, without modifying the instantiated construct or the solving.

In a first step, a target constant or characteristic scale is specified as input (110). The target specification may identify a particular constant (for example, a coupling constant, a particle mass scale, a characteristic length in a biological structure, or a characteristic coherence energy) and may include metadata describing the target class, such as whether the target is dimensionless, a length, an energy, or a mass. The workflow classifies the target (120) in order to determine which family of RS/RP constructs is applicable for the derivation. By way of example, dimensionless targets may be mapped to cost-functional embodiments; length and energy targets may be mapped to scale-cascade embodiments; and mass targets may be mapped to operator/spectrum embodiments and/or to energy-to-mass mapping embodiments. The target specification can further include a requested reporting unit and a declaration of whether the output should be provided in RS-native form or in a reporting unit through an explicit calibration seam.

In a second step, the workflow defines a target system within RS/RP (130). System definition includes assigning recognition geometry parameters, such as a dimensionality parameter d and a class or spin parameter s, and optionally assigning an interaction-type tag that indicates whether the target is treated as electromagnetic, strong, gravitational, geometric, biological, or otherwise.

The system definition step may also assign one or more constraints or boundary conditions appropriate for an operator embodiment and may specify whether the target is derived by an optimization criterion (for cost functional embodiments), by a spectral criterion (for operator embodiments), or by a scale-index criterion (for cascade embodiments). The system definition step therefore produces an RS/RP system representation that constrains the later construct formulation and restricts the solution space to admissible RS/RP-consistent solutions.

In a third step, the workflow selects and formulates a construct family for the target (140). In disclosed embodiments, the construct family selection partitions the workflow into at least three construct families. A cost-functional path (150) formulates an objective function or cost functional in which an unknown parameter (for example, a scale parameter or coupling parameter) is determined by minimizing a cost or deviation from a self-similarity target. An operator/spectrum path (160) formulates an operator-based recognition construct, such as a self-adjoint operator whose spectral quantities (eigenvalues, spacings, or invariant values) define the target constant or scale. A scale-cascade path (170) formulates a cascade relationship that maps an index to a physical scale using a universal scale factor and a declared anchor convention, such that a discrete or continuous index corresponds to a derived length, energy, or mass. In each case, construct formulation fixes the mathematical form of the construct using RS/RP-defined quantities and constants, including phi, pi, and derived RP constants such as X_opt, and may incorporate additional RP modulators where disclosed, while excluding target-specific empirical values in the construct definition.

In a fourth step, the workflow solves the selected construct in a parameter-free manner and extracts a derived output (180), (190). For cost-functional constructs, solving may include numerical integration over a defined domain and minimization of the cost functional to obtain a minimizing parameter value. For operator/spectrum constructs, solving may include discretization of the operator and computation of spectral quantities through an eigenvalue solver or other spectral method. For cascade constructs, solving may include computing cascade values for a selected index, or scanning candidate indices and selecting an index according to a disclosed minimal overhead criterion. The workflow then extracts the target constant or scale from the solution (190), and generates a derivation trace artifact (195) that records the selected construct family, the construct definition, constants used, solver settings, intermediate values, and final output. The derivation trace provides reproducibility and auditability for the derivation and enables validation and verification steps to be performed without reintroducing empirical fitting at the construct-definition stage.

The methods disclosed herein are implementable in a computing environment and provide at least one concrete way to make and use a system that derives physical constants and characteristic scales using RS/RP constructs. FIG. 2 illustrates a computing system architecture (200) that can implement the derivation workflow of FIG. 1, including a user device or client (210) communicating over a network interface (220) with a derivation server or computing device (230). The derivation server (230) executes a system definition module (240), a construct formulation module (250), a solver module (260), and an extraction module (270). In certain embodiments, the derivation server (230) further executes an optional validation module (280) and a derivation trace generator (290). In certain embodiments, the system includes a data store or database (292), an API endpoint or service interface (294), optional distributed compute resources such as a job queue or compute node pool (296), and an optional audit or log store (298). The modules, interfaces, and stores are configured to implement the four-step derivation workflow described herein in a repeatable and auditable manner, while maintaining the parameter-free constraint at the construct-definition and construct-solution stages and applying any calibration seam only at a declared reporting stage.

A target constant or scale is provided to the computing system as an input data structure TargetSpec, which may be transmitted from the user device (210) to the derivation server (230) via the network interface (220). In embodiments, TargetSpec includes a target identifier (for example, a constant name or a scale name), a target class designation, and one or more descriptors that constrain the RS/RP system definition. The target class designation may specify whether the target is dimensionless, a length, an energy, or a mass, thereby enabling the derivation server (230) to select among cost-functional, operator/spectrum, or scale-cascade derivations. The descriptors may include recognition geometry parameters such as a dimensionality parameter d and a class or spin parameter s, and may include an interaction tag indicating an electromagnetic, strong, gravitational, geometric, or biological embodiment. The input may further include reporting preferences identifying whether to output an RS-native value or a value expressed in reporting units, and if reporting units are requested the input may include a declaration selecting a calibration seam to be applied at a reporting stage, without altering the construct definition or construct solution.

In response to receiving TargetSpec, the derivation server (230) invokes the system definition module (240) to parse the input, assign the target class, assign or confirm the recognition geometry parameters, and define an RS/RP system representation that constrains the subsequent construct formulation. The derivation server (230) invokes the construct formulation module (250) to select and instantiate a construct family consistent with the system representation. In embodiments, the construct formulation module (250) selects a cost-functional construct family for dimensionless targets, an operator/spectrum construct family for targets derived from spectral quantities, and a scale-cascade construct family for targets derived from indexed scale cascades.

The construct formulation module (250) then generates a formal construct definition, including the applicable cost functional, operator form, cascade relation, constants used, and any declared constraints or boundary conditions that are part of the embodiment.

The derivation server (230) invokes the solver module (260) to compute a solution for the instantiated construct. The solver module (260) may include one or more operational parameters that control convergence and reproducibility, including a solver tolerance value solver_tolerance, an integration window parameter x_max used to truncate a domain such as integral_0\hat{ }infty to a finite window [0, x_max], a basis size or discretization resolution used for operator discretization, a maximum iteration count, and an index search range or index selection policy used for cascade embodiments. These operational parameters are not target-specific empirical fitting parameters; rather, they are numerical computation parameters used to ensure convergence and reproducibility of the disclosed computations. For cost-functional embodiments, the solver module (260) performs numeric integration and minimization until a convergence criterion is satisfied. For operator embodiments, the solver module (260) discretizes the operator over a defined domain and computes eigenvalues, eigenfunctions, or other spectral invariants under defined boundary conditions. For cascade embodiments, the solver module (260) computes one or more candidate cascade values r_n or E_n for candidate indices and applies an index selection criterion, such as a minimal overhead selection criterion, to select a preferred index and corresponding cascade output.

In one non-limiting implementation example for a cost-functional embodiment, the solver module sets solver_tolerance to 1e−8, sets x_max to 50 to truncate an integration domain to [0, x_max], and sets max_iter to 500. The solver module numerically evaluates the disclosed cost functional over the truncated domain and applies a bounded minimization procedure over a declared search interval for the minimizing parameter, terminating when a convergence criterion consistent with solver_tolerance is satisfied or when max_iter is reached.

In this example implementation, the derivation trace records at least the selected solver_tolerance, x_max, max_iter, an identifier of the numerical integration routine used, an identifier of the minimization routine used, and at least one intermediate value associated with the final minimization output (for example, a final objective value at the minimizer), together with the derived_value extracted from the solver result.

Upon computation of a solution, the derivation server (230) invokes the extraction module (270) to extract a derived constant or scale value from the computed solution. In embodiments, extraction includes converting the solution into the target type, such as extracting a minimizing scale parameter from a cost functional, extracting a spectral quantity from an operator solution, or extracting a cascade value from an indexed cascade. For mass targets, extraction may include mapping an energy output to a mass via m=E/c\hat{ }2 and applying any disclosed RP modulation factors where applicable to the target class. The extraction module (270) formats the derived output for presentation and, when requested, applies a declared calibration seam at a reporting stage to express the derived output in reporting units. In embodiments, the extraction module (270) produces both an RS-native representation and a reporting-unit representation, together with a statement of the calibration seam applied.

The derivation trace generator (290) generates a derivation trace artifact that records the target input, selected construct family, construct definition, constants used, solver settings, intermediate results, and the extracted final value. In embodiments, the derivation trace artifact is stored in the data store (292) and optionally in the audit/log store (298) to support reproducibility and auditability. In embodiments, the derived output and the derivation trace are provided to the user device (210) directly or via an API endpoint (294) that returns a structured response. The validation module (280), when enabled, computes one or more validation metrics, such as (i) a fractional deviation relative to a known reference value when such a reference is available, and/or (ii) an internal consistency metric when no external reference is available. One example internal consistency metric is a stability metric that compares the derived_value produced under two disclosed numerical controls (for example, two integration window truncations x_max and 2*x_max, or two discretization resolutions) and computes a relative change metric=|v2−v1|/max(|v1|, eps). The validation module (280) applies a decision rule, such as outputting a pass/fail/flag status based on whether the validation metric satisfies a declared threshold, and records the metric, threshold, and decision in the derivation trace artifact. In this manner, the computing system (200) provides an implementable, repeatable, and auditable platform for parameter-free derivation of physical constants and scales using RS/RP constructs, with explicit separation between parameter-free construct solving and any reporting-unit mapping performed via a declared calibration seam.

In embodiments, the derivation trace artifact is formatted as a machine-readable record (for example, a JSON record, a database row, or a structured log entry) having at least: (i) target_id and target_class; (ii) system representation fields including recognition geometry parameters used; (iii) construct_family and a construct_definition_payload that includes the operative equations and any boundary/domain constraints invoked; (iv) constants_used identifying RS/RP constants and identities applied; (v) solver_settings including solver_tolerance, iteration limits, integration window parameters, discretization resolution, and/or index search range when applicable; (vi) intermediate_values including at least one solver output quantity used for extraction; (vii) derived_value as extracted; and (viii) when validation is enabled, validation_metric, validation_threshold, and validation_decision.

Cost-functional embodiments disclosed herein derive an unknown physical constant, coupling, or characteristic scale parameter by formulating an RS/RP-consistent objective function and solving for a parameter value that minimizes the objective. FIG. 4 illustrates a cost-functional derivation subflow (400) including a coverage function block (410), a self-similarity target block (420), a cost functional definition block (430), a minimization/solver block (440), an output block for an optimal recognition scale X_opt (450), and optional numerical settings including a tolerance parameter (460) and integration window parameters (470). In these embodiments, the cost functional is constructed to penalize deviations from a self-similar recognition target over a continuous domain, and the derived output is defined as the minimizer (or an extremum) of the disclosed functional under RS/RP constraints.

FIG. 4 depicts a cost-functional derivation subflow (400) in which a coverage function is defined (410), a self-similarity target is specified (420), a cost functional is constructed (430) and minimized using a minimization/solver stage (440) to output an optimal recognition scale Xopt (450), with numerical computation controls including a convergence tolerance parameter (460) and an integration-window/truncation policy (470) treated as numerical controls rather than target-specific fit parameters.

In RS-based embodiments, a base cost primitive is expressed as J(x)=0.5*(x+1/x)−1 for x>0, where x is a positive ratio that may represent a scale ratio, a recognition ratio, or an equivalent positive scalar quantity used to parameterize recognition. Compound costs and multi-stage recognition costs may be constructed subject to the Recognition Composition Law J(x*y)+J(x/y)=2*J(x)*J(y)+2*J(x)+2*J(y) for x>0 and y>0. In practical embodiments, the base cost primitive and its composition law justify constructing an aggregate cost functional that integrates or aggregates cost contributions across a range of scales, and the minimizer of the functional is treated as the physically preferred or recognition-stable parameter value. In this manner, optimization of a cost functional provides a parameter-free selection mechanism for constants and scales, in which the derived value is determined by the structure of the functional rather than by fitting to the target value.

One cost-functional embodiment determines an optimal recognition scale X_opt by minimizing a coverage-based functional. In this embodiment, a recognition coverage function is defined as coverage(x,X)=(x/(x+X))\hat{ }2 (410), where x is a nonnegative scalar variable and X is an unknown scale parameter to be determined. A self-similarity target is defined as phi\hat{ }(−2) (420). A cost functional is then defined as J_cov(X)=integral_0\hat{ }infty[((x/(x+X))\hat{ }2−phi\hat{ }(−2))\hat{ }2]dx (430). The minimization problem is defined by solving the stationarity condition dJ_cov/dX=0 (440), with the derived output defined as the minimizer X_opt (450). In disclosed embodiments, the minimizer corresponds to X_opt=phi/pi (450). Numerical implementations may evaluate the improper integral by truncating the domain to a finite integration window [0, x_max] and applying a numerical integration routine under a specified integration window policy (470). A numerical minimization procedure may then be executed under a specified convergence tolerance (460), optionally with convergence verification by increasing x_max and confirming that the minimizer remains stable within the tolerance. The tolerance (460) and integration window selection (470) are treated as numerical computation controls rather than target-specific fit parameters, and the derived output is defined by the functional and its minimization criterion.

Cost-functional embodiments may also be used to derive coupling constants, including electromagnetic coupling representations, by defining a coupling-dependent functional whose minimizer corresponds to a coupling parameter. FIG. 9 illustrates a fine-structure derivation subflow (900) including an embodiment selector (910), an optional functional block (920), a seed term block (930), a closed-form alpha inverse block (940), an eight-tick/log term block (950), a curvature/geometry correction term block (960), a combination block (970), an output block (980), and an optional validation block (990). In a functional-minimization embodiment, a coupling functional is defined as J_EM(alpha)=integral_0\hat{ }infty[((x/(x+alpha))\hat{ }2−(R_RP*eta_RP)\hat{ }2)\hat{ }2]dx (920), where alpha is the coupling parameter to be determined and (R_RP*eta_RP)\hat{ }2 defines a recognition-geometry target in that embodiment. In such embodiments, a seed value may be defined as alpha_seed=(R_RP\hat{ }2)*(eta_RP\hat{ }2)=( 7/12)\hat{ }2*(⅝)=49/1152 (930), which may serve as an initial condition, a reference point, or an internally motivated baseline value within the coupling derivation. A minimization procedure analogous to that described for J_cov(X) may be applied to the coupling functional, using an appropriate integration window and tolerance policy, to determine a derived coupling value.

FIG. 9 depicts an example fine-structure derivation subflow (900) including an embodiment selector (910) for choosing among alternative derivation pathways, an optional functional-minimization block (920) optionally initialized using a seed term block (930), an alternate closed-form inverse coupling block (940), an eight-tick/log term block (950), a curvature/geometry correction term block (960), a combination block (970) to form α and/or αinv, an output block (980), and an optional validation block (990) that computes one or more validation metrics and records the results in the derivation trace.

In an alternate embodiment illustrated in FIG. 9, an inverse coupling is derived in closed form using RS/RP-derived terms rather than functional minimization. In this embodiment, alpha_inv is defined as alpha_inv=4*pi*11−w8*ln(phi)+103/(102*pi\hat{ }5) (940), where w8 is an eight-tick projection weight (950), ln(phi) is the natural logarithm of phi (950), and 103/(102*pi\hat{ }5) is a curvature/geometry correction term (960). The terms are combined as specified to form alpha_inv and, where needed, to derive alpha from alpha_inv (970), producing an output alpha and/or alpha_inv (980). In certain embodiments, an optional validation procedure compares the derived output to a reference value and computes one or more validation metrics (990). The embodiment selector (910) indicates whether a functional-minimization embodiment (920) is applied, a closed-form embodiment (940) is applied, or both are applied to produce multiple outputs and/or cross-checks within a derivation trace. In this manner, the cost-functional construct family provides both minimization-based and closed-form pathways for deriving constants, while maintaining an internally defined RS/RP structure for the construct definition and defining the derived output as the result of an RS/RP-consistent computation rather than target-specific empirical fitting.

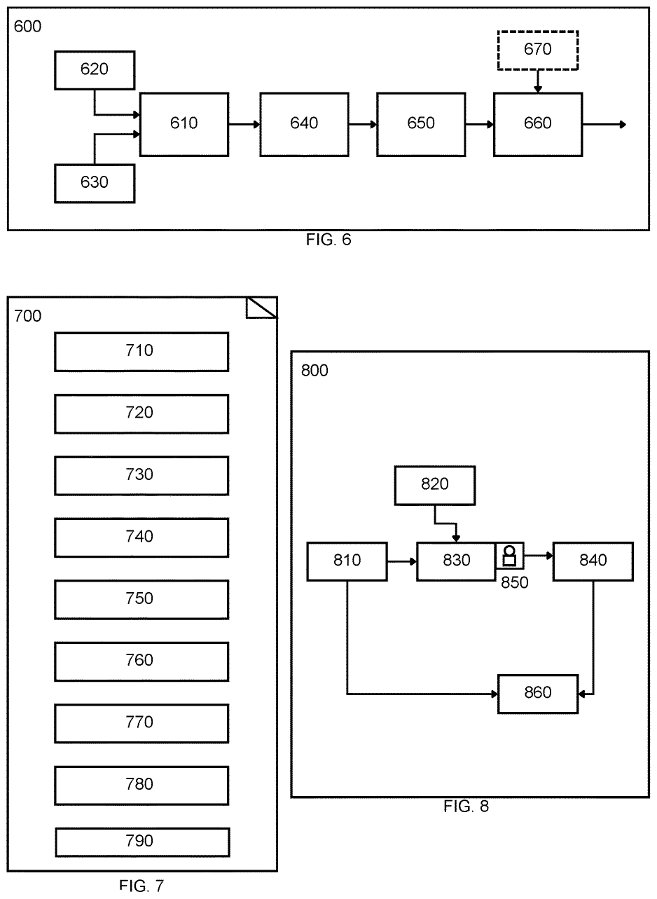

Operator, spectrum, and recognition-operator embodiments disclosed herein derive physical constants and characteristic scales by defining a recognition-consistent operator construct and extracting one or more invariant quantities from the operator's behavior, such as eigenvalues, eigenvalue spacings, fixed points, periodicities, or other spectral characteristics. FIG. 6 illustrates an operator/spectrum derivation subflow (600) including operator construction (610), potential selection (620), boundary/domain specification (630), an eigenvalue solver (640), extraction of a spectral quantity (650), mapping to a derived scale or mass (660), and optional modulation factors (670). In these embodiments, the operator construct provides an internally specified, parameter-free mechanism for generating discrete or quasi-discrete outputs, and the derived physical quantity is defined by a disclosed extraction rule applied to the computed operator solution.

FIG. 6 depicts an operator/spectrum derivation subflow (600) including operator construction (610), potential selection (620), boundary/domain specification (630), computation of one or more eigenvalues using an eigenvalue solver (640), extraction of a spectral quantity under a disclosed extraction rule (650), mapping of the extracted spectral quantity to a derived scale or mass (660), and optional modulation factors (670), with boundary conditions and solver settings captured in the derivation trace to support reproducible reruns of the spectral computation.

In certain embodiments, an operator is constructed as a self-adjoint or otherwise spectrally well-posed operator H_hat (610) acting on a state function psi over a defined domain, with the derived constant or scale obtained from a selected eigenvalue or spectral invariant. One example operator form is H_hat=−i*x*(d/dx)−i/2+k*X_opt*(x+X_opt*V(x)), where x is a domain coordinate, k is a scaling factor consistent with the disclosed embodiment, X_opt is an optimal recognition scale, and V(x) is a recognition potential selected to model the target class. The operator construction (610) fixes the structural form of the operator using RS/RP-derived quantities, and the subsequent steps compute the operator's spectrum under disclosed domain and boundary constraints.

The boundary and domain specification (630) defines the admissible space on which the operator acts and constrains the solution to physically and recognition-consistent states. In embodiments, the domain specification identifies the interval or region over which x is defined, the regularity class required for psi, and the boundary conditions imposed at one or more endpoints or asymptotic limits. Suitable boundary conditions include, by way of example, normalizability constraints, vanishing boundary constraints, periodic boundary constraints, or mixed boundary constraints, selected in accordance with the target system class and the recognition geometry parameters used in the system definition step. The boundary/domain specification (630) is treated as part of the construct definition and is recorded in the derivation trace, enabling reproducibility and auditability of the spectral computation.

The potential selection (620) specifies a recognition potential V(x) used to encode system-class structure within the operator construct. In certain embodiments, an exponentially decaying potential is used for targets associated with localized interactions or screening behavior, for example V(x)=exp(−X_opt*x) or another decay form with a recognition-scale dependence. In certain embodiments, a periodic potential is used for targets associated with repeating structure, for example a cosine-form periodicity V(x)=cos(2*pi*x/P) where P is a period parameter tied to a derived or selected structural scale. In certain embodiments, a confining potential is used for targets associated with bound or confined behavior, for example linear or quadratic confinement forms. The selection of V(x) (620) is made consistent with the target class and system definition, and is disclosed as an embodiment choice that affects which spectral quantities are extracted (650) and how they map to derived constants or scales (660).

Once the operator is fully defined by operator construction (610), potential selection (620), and boundary/domain specification (630), the eigenvalue solver (640) computes eigenvalues E_j and, where applicable, eigenfunctions psi_j by solving an eigenvalue equation of the form H_hat*psi=E*psi. Implementations may discretize the operator and compute eigenvalues using numerical eigensolvers, basis expansions, finite differences, finite elements, spectral methods, or other numerical approaches that provide convergent approximations to the relevant portion of the spectrum. The eigenvalue solver settings, including discretization resolution, basis size, convergence tolerance, and any stabilization parameters, are treated as numerical computation controls and are captured in the derivation trace artifact, without being treated as target-specific fitting parameters.

After eigenvalues are computed, an extracted spectral quantity (650) is selected according to a disclosed extraction rule. For example, the extracted quantity may be a lowest eigenvalue, an eigenvalue spacing between successive eigenvalues, an eigenvalue ratio, a threshold eigenvalue associated with a stability transition, or another invariant derived from the computed spectrum.

The extraction rule defines the target output in a reproducible way, such that the same operator definition yields the same extracted quantity (subject to solver tolerance). The extracted spectral quantity (650) is then mapped to the desired constant or scale (660). In embodiments in which the extracted spectral quantity is an energy, mapping may include converting an energy to a mass via m=E/c\hat{ }2 and/or converting an energy to a characteristic frequency or length using disclosed relations. In embodiments in which the extracted spectral quantity corresponds directly to a length scale or a dimensionless ratio, the mapping rule may output the quantity directly or apply a disclosed scale factor consistent with the construct definition.

The extraction rule defines, in a reproducible way, which computed quantity is treated as the extracted output of the construct solution, and how that quantity is mapped to the requested target type.

In a cost-functional embodiment, extraction comprises selecting X_opt as the value of X that minimizes J_cov(X) over X in [X_min, X_max] under solver settings. In embodiments, the extracted value is the argmin X_opt returned by the minimizer, together with an uncertainty proxy equal to the absolute change in X_opt when an integration-window parameter x_max is increased from x_max to 2*x_max.

In a cascade embodiment, extraction comprises computing r_n=L_anchor·(X_opt)\hat{ }n and/or E_n=E_anchor·(X_opt)\hat{ }n for the selected index n, and outputting the computed r_n and/or E_n as the derived value. When a mass is requested, extraction further comprises mapping an energy output to a mass using m=E/c\hat{ }2.

In an operator embodiment, extraction comprises computing at least the first two eigenvalues {E1, E2} of H_hat under declared boundary conditions and solver settings, and extracting a spectral quantity as ΔE=E2−E1. The derived value is computed as: (i) an energy output equal to ΔE, or (ii) a mass output equal to ΔE/c\hat{ }2, as specified by the target class.

In another operator embodiment, extraction comprises selecting a lowest eigenvalue E1 that satisfies a stability predicate S(E1)=true, where S(E) is evaluated as convergence of E under two discretization resolutions within tolerance ε_spec, and outputting E1 as the extracted spectral quantity.

Solver settings include at least one of: discretization resolution(s), basis size, convergence tolerance, maximum iterations, and boundary-condition identifiers, and are recorded in the derivation trace to support reproducible re-computation of the extracted quantity.

In certain embodiments, optional modulation factors (670) are applied during mapping to reflect recognition-geometry or system-class effects that are treated as universal within RP embodiments. By way of example, a modulation may include a factor of the form R_RP\hat{ }p and/or eta_RP\hat{ }q for integers or rational exponents p and q selected according to the target class (for example, a fermionic multiplicity, a confinement class, or a dimensionality class). These modulation factors (670) are not introduced as empirical fit parameters; rather, they are disclosed as embodiment constants derived from RS/RP structure and applied according to disclosed selection rules so that the mapping from an extracted spectral quantity (650) to a derived constant or scale (660) remains internally specified and auditable.

In addition to the self-adjoint operator embodiment, certain embodiments use a recognition operator R_hat to represent recognition evolution directly. In these embodiments, recognition evolution is represented as a discrete-time update consistent with an eight-tick cadence, for example s(t+8*tau0)=R_hat(s(t)), where s(t) is a system state at time t and tau0 is a fundamental tick. In such embodiments, the derived constant or scale is obtained from invariant behavior of the recognition evolution, such as a fixed point, a periodic orbit, a stable cycle, a convergence rate, an invariant measure, or an eigen-quantity of the recognition operator's linearization about a stable state. The recognition operator embodiment enables derivations in which the primary selection principle is expressed as recognition stability under repeated application of R_hat, and the outputs are defined by stable structures of the recognition dynamics rather than by energy minimization.

In certain implementations, the operator H_hat is treated as an approximation, surrogate, or computationally convenient representation of recognition dynamics, where spectral computation provides an efficient method for extracting invariant quantities associated with stable recognition behavior. In such embodiments, R_hat defines the underlying recognition evolution and H_hat provides a tractable operator form for computing spectral quantities that serve as proxies for recognition invariants. Whether the derivation uses H_hat directly or uses R_hat directly, the disclosed operator-family embodiments define the derived output as a function of an internally specified construct and an auditable extraction rule, enabling parameter-free derivation of constants and scales with a reproducible computation trace.

Universal scale cascade embodiments disclosed herein derive dimensional physical scales by mapping a discrete or continuous index to a length or energy output using a universal scale factor and a declared anchor convention. FIG. 5 illustrates a scale cascade subflow (500) including a length cascade definition (510), an energy cascade definition (520), an anchor selection block (530), an index selection block (540), example indices (550), (560), (570), derived outputs (580), and positivity/monotonicity indicators (590). In these embodiments, the cascade provides a compact computational mechanism for producing characteristic lengths and energies from RS/RP-defined quantities, while maintaining an explicit separation between (i) parameter-free derivation of RS/RP outputs and (ii) reporting in SI or other conventional units using a declared external calibration choice.

FIG. 5 depicts a scale-cascade derivation subflow (500) including definition of a length cascade relation (510) and an energy cascade relation (520), selection of an anchor convention (530), selection of a cascade index according to a minimal-overhead criterion (540) including example indices (550), (560), and (570), computation of derived outputs (580), and optional feasibility indicators such as positivity and/or monotonicity checks (590) recorded in the derivation trace to preserve reproducibility of the index selection and computed cascade output.

A length cascade is defined as (510) r_n=L_anchor*(X_opt)\hat{ }n, where r_n is a derived length output for index n, L_anchor is an anchor length, and X_opt is an optimal recognition scale. An energy cascade is defined as (520) E_n=E_anchor*(X_opt)\hat{ }n, where E_n is a derived energy output for index n and E_anchor is an anchor energy. In certain embodiments, X_opt is a universal RP constant that is derived without empirical fitting and satisfies 0<X_opt<1.

Because the cascade is multiplicative in (X_opt)\hat{ }n, the index n determines the scale separation between the anchor and the derived output. In implementations, n may be an integer index, and in some embodiments n may be allowed to be real-valued and selected through continuous optimization, with optional rounding to an integer for applications that require discrete indexing.

Anchor selection (530) defines how L_anchor and E_anchor are chosen and how cascade outputs are mapped to reporting units. In certain embodiments, the anchor length and anchor energy are treated as RS-native reference scales and can be normalized within an internal RS-native unit system, with conversion to SI units treated as an explicit external calibration choice. In certain embodiments providing SI values, the anchor length and anchor energy are chosen using Planck anchoring as external anchors, where L_anchor=L_Planck=sqrt(hbar*G/c\hat{ }3) and E_anchor=E_Planck=sqrt(hbar*c\hat{ }5/G) as a reporting convention. In such embodiments, the Planck anchors are used to express cascade outputs in SI or electron-volts while preserving the parameter-free nature of the cascade computation itself, because the cascade computation uses the disclosed formula and the selected index n, and the anchoring is applied as a declared unit-mapping choice rather than as target-specific empirical tuning. In alternate embodiments, the anchors are established through a declared calibration seam and the cascade outputs are reported using that seam, provided the seam is declared once and applied consistently across targets as described elsewhere herein.

Index selection (540) determines the cascade index n used to compute a derived output. In these embodiments, the cascade index n is the key output of the Minimal Overhead principle, and may be expressed as a function n=f(d, s) where d is a relevant spatial dimensionality and s is a class, spin, or generation parameter for the target system. The selection principle is that, among candidate indices, the index that minimizes recognition overhead for the given system class and recognition geometry is selected. The selection process may be implemented as a discrete optimization over integer n values, as a continuous optimization over real n values, or as a hybrid method that evaluates a finite candidate set and selects the index achieving a minimal overhead score. The index selection block (540) is therefore a computable selection stage that converts the system definition parameters into a chosen cascade index, and is recorded in the derivation trace to preserve reproducibility.

Exemplar index assignments are disclosed to illustrate how the cascade may be applied to derive characteristic scales. In one embodiment, an index n=−90 corresponds to an inter-strand DNA groove length scale (550). In another embodiment, an index n=101 corresponds to a DNA excitonic coherence energy (560). In another embodiment, an index n=−123 corresponds to a Bohr-radius-scale length associated with Coulomb recognition in three dimensions (570).

Additional indices may be used for other system classes, and the derived values are captured as derived outputs (580) for the selected index. In certain embodiments, derived outputs (580) include both r_n and E_n, and may further include a mapped mass output obtained by converting an energy output to a mass using m=E/c\hat{ }2 where such mapping is part of the target definition.

Whether the derived output is a length, an energy, or a mass, the output is defined as the result of evaluating the disclosed cascade formula at the selected index, together with any disclosed mapping rule required to express the output in the target type.

The cascade embodiments further provide algebraic and ordering properties that support stability and validation of derived outputs. In particular, positivity properties are disclosed (590), including r_n>0 for all indices n and E_n>0 for all indices n. In embodiments where 0<X_opt<1 and where n is increased by one, the cascade produces a monotonic shrink property for the length cascade, such as r_{n+1}<r_n for all indices n, which reflects that successive indices correspond to progressively smaller length scales. Related monotonicity properties may be defined for energy outputs depending on the sign convention and whether the derived energy scale increases or decreases as a function of n. These properties are useful both for internal consistency checks (for example, confirming that cascade outputs remain positive) and for computational validation rules that can be applied when external references are not available.

The cascade's dependence on RS/RP constants also supports a compact representation of the derivation chain, because once X_opt and the anchor convention are fixed, the primary system-specific selection step is the index selection process (540).

The derivation methods disclosed herein distinguish between (i) parameter-free computation of RS/RP-native quantities and relationships and (ii) expression of derived outputs in conventional reporting units such as SI units or electron-volts. This distinction is implemented using a calibration seam that is explicitly declared and applied at a reporting stage without altering the parameter-free construct definition and construct solution stages. FIG. 8 illustrates a calibration seam diagram (800) including RS-native output quantities (810), declared anchor parameter(s) (820), a mapping or conversion function (830), reporting-units outputs (840), a no-target-specific-fitting constraint indicator (850), and an optional cross-output consistency check block (860). In the embodiments disclosed herein, RS/RP constructs are solved in RS-native form to produce intermediate and final values that are internally consistent under RS/RP identities.

Reporting in SI or other units is then performed by applying the mapping function (830) to the RS-native outputs (810) using the declared anchor parameter(s) (820), while maintaining the constraint that no target-specific fitting is introduced (850).

RS-native quantities (810) include, by way of example, dimensionless constants and ratios derived from RS/RP structure, as well as RS-native time and length primitives such as a fundamental tick tau0 and a spatial step ell0, and RS-native energy primitives such as a coherence quantum E_coh. RS-native quantities further include RS/RP-derived relations such as c=ell0/tau0 and hbar=E_coh*tau0, and may include cascade outputs r_n and E_n expressed in terms of RS-native anchors. These RS-native outputs (810) are computed by the disclosed construct families without inserting empirically measured values specific to any target constant at the stage of defining or solving the construct. In this manner, the derivation stage generates internally consistent results whose numerical representation is tied to RS-native units rather than directly to SI or other conventional units.

The declared anchor parameter(s) (820) define an explicit mapping between RS-native units and reporting units. In certain embodiments, a single-anchor seam is used in which one RS-native primitive is assigned an external numerical value in reporting units, and all other reporting-unit quantities are derived using the RS/RP identities and the mapping function (830). For example, in a single-anchor embodiment, a parameter tau0_seconds may be declared as the number of seconds per RS tick, and this declared value is used solely as a reporting anchor. In such embodiments, once tau0_seconds is declared, the mapping function (830) can convert RS-native time values to seconds, RS-native rates to per-second units, and RS-native spatial values to meters by using the RS/RP speed relation c=ell0/tau0 together with an externally specified reporting value for c if c is treated as part of the reporting convention, or by mapping ell0 to meters using ell0_meters=c_SI*tau0_seconds as a reporting conversion rule. In energy reporting, the IR-gate identity hbar=E_coh*tau0 provides a mapping relationship that can be used to express an RS-native action unit in SI units given a declared seam, such that a reporting-unit value for hbar may be used as part of the reporting convention if explicitly declared as an anchor, or alternatively such that E_coh can be mapped to joules or electron-volts through the seam and the identity. In each case, the anchor parameter(s) (820) are declared explicitly and are treated as part of the reporting layer rather than as adjustable variables used to match target outcomes.

In other embodiments, the declared anchor parameter(s) (820) define an anchor set rather than a single scalar. One example anchor set is Planck anchoring, where a reporting-unit convention is established using L_Planck=sqrt(hbar*G/c\hat{ }3) and E_Planck=sqrt(hbar*c\hat{ }5/G) and where cascade anchors L_anchor and E_anchor are set equal to L_Planck and E_Planck for purposes of reporting cascade outputs in SI or electron-volts. In such embodiments, the anchoring is treated as a declared unit-mapping convention that enables reporting of cascade values and other derived outputs. The cascade computation itself remains parameter-free because the cascade outputs are defined by the disclosed cascade relations and the selected index. The anchor set is not varied per target constant, and any use of standard constants in the anchor set is treated as part of the reporting convention rather than as target-specific fitting.

The mapping or conversion function (830) applies the declared anchor parameter(s) (820) to the RS-native outputs (810) to generate reporting-unit outputs (840). In embodiments, the mapping function (830) comprises one or more explicit equations or mappings that convert RS-native units to reporting units, including conversions from RS-native time to seconds, RS-native length to meters, RS-native energy to joules or electron-volts, and RS-native derived constants to SI-derived units. The mapping function (830) may include dimension analysis checks, consistency checks, and normalization steps that ensure the converted values satisfy the declared unit conventions. When multiple reporting-unit outputs are generated from the same RS-native basis, the mapping function (830) is applied consistently across those outputs so that the overall reporting set is coherent and auditable.

A key constraint of the calibration seam is that no target-specific fitting is introduced (850). This constraint means that the declared anchor parameter(s) (820) are not chosen separately for different targets in order to force agreement with known values of those targets. Instead, the anchor parameter(s) are declared once for a given reporting convention and then applied across multiple targets. In implementations, this constraint can be enforced by storing the declared seam configuration as a system-level setting and preventing per-target modification at runtime, or by recording the seam configuration in the derivation trace so that any variation is detectable. The calibration seam therefore acts as a reporting layer boundary that preserves the parameter-free nature of the RS/RP derivation stage.

In certain embodiments, an optional cross-output consistency check is performed (860). The cross-output consistency check evaluates whether multiple derived outputs produced from the same RS-native basis are mutually consistent under RS/RP identities and under the declared seam. For example, if c=ell0/tau0 is used and a seam declares tau0_seconds, then mapping ell0 to meters using ell0_meters=c_SI*tau0_seconds should be consistent with other mapped quantities that depend on ell0 and tau0. Similarly, if hbar=E_coh*tau0 is used, then mapping E_coh to electron-volts should be consistent with the mapped action quantity implied by the seam. Consistency checks can also compare cascade-derived energies and lengths against each other when both are derived from the same X_opt and the same anchor convention. The cross-output consistency check (860) may produce a metric recorded in the derivation trace, and may trigger a flag if internal consistency fails, thereby providing an auditable safeguard that the reporting mapping has been applied correctly without introducing hidden fitting.

The following example embodiments illustrate end-to-end operation of the disclosed RS/RP derivation workflow and provide worked implementations that are sufficiently detailed to enable computation of representative constants and characteristic scales. The examples are presented to demonstrate how the target specification, construct selection, parameter-free solution, extraction, and optional reporting are carried out using the disclosed construct families. In these examples, the derived output is defined by the disclosed construct and the disclosed extraction rule, and a derivation trace may be produced to record the pathway, constants used, solver settings, intermediate results, and final output. Unless otherwise stated, numerical integration, minimization, and spectral computation may be implemented using standard numerical methods under a declared tolerance and truncation policy, with those numerical settings treated as computational controls rather than target-specific fitting parameters.

A first example embodiment derives an optimal recognition scale X_opt using a cost-functional minimization pathway illustrated in FIG. 4. In this embodiment, the target specification is an optimal scale parameter and the workflow selects a cost-functional construct. A coverage function is defined as coverage(x,X)=(x/(x+X))\hat{ }2 (410), and a self-similarity target is defined as phi\hat{ }(−2) (420). A cost functional is then defined as J_cov(X)=integral_0\hat{ }infty[((x/(x+X))\hat{ }2−phi\hat{ }(−2))\hat{ }2]dx (430), and a minimization criterion is applied (440) to determine a minimizing value of X. In practical implementation, the integral is evaluated numerically by truncating the domain to [0, x_max] under an integration window policy (470), and a numerical optimizer is applied under a convergence tolerance policy (460). The derived output X_opt is defined as the minimizer (450), and in embodiments the minimizer corresponds to X_opt=phi/pi (450). The derivation trace records the selected construct family, the cost functional definition, the integration window parameters, the optimizer settings, the resulting minimizer, and any convergence checks performed.

A second example embodiment derives a characteristic DNA groove length scale using the universal scale cascade pathway of FIG. 5. In this embodiment, the target specification identifies a length scale associated with a DNA groove geometry and the workflow selects the length cascade construct. A length cascade is defined as r_n=L_anchor*(X_opt)\hat{ }n (510), where X_opt is taken from the previously derived optimal recognition scale or from a directly specified RP constant, and L_anchor is selected under a declared reporting convention (530). An index selection is performed (540) using a minimal overhead rule that assigns an index to the target class. For this DNA groove length embodiment, an exemplar index n=−90 is selected (550). The derived length output is computed as r_−90=L_anchor*(X_opt)\hat{ }(−90) (580). When reporting in Angstroms is desired, the calibration seam and unit mapping of FIG. 8 are applied as described elsewhere to map the computed length to a reporting unit, yielding a reported output corresponding to a DNA groove length scale. The derivation trace records the selected index (550), the anchor selection (530), the computed cascade value (580), and any mapping parameters used.

A third example embodiment derives a characteristic coherence energy using the energy cascade and, when desired, unit reporting through the calibration seam. In this embodiment, the target specification identifies a coherence energy associated with a DNA excitonic coherence regime, and the workflow selects the energy cascade construct. An energy cascade is defined as E_n=E_anchor*(X_opt)\hat{ }n (520), where E_anchor is selected under a declared reporting convention (530). An index selection is performed (540) and, for this coherence energy embodiment, an exemplar index n=101 is selected (560). The derived energy output is computed as E_101=E_anchor*(X_opt)\hat{ }(101) (580). If the output is to be expressed in electron-volts, the calibration seam mapping is applied as shown in FIG. 8, with RS-native outputs (810) mapped through declared anchor parameter(s) (820) and a conversion function (830) to reporting outputs (840). In embodiments, an internal RS/RP coherence quantum E_coh may also be used as a coherence-energy primitive in RS-native form, and the cascade-derived coherence energy may be used as a cross-check or as a selection reference within a derivation trace. An optional cross-output consistency check may be performed (860) to verify that the reported energy is consistent with other RS/RP identities under the declared seam. The derivation trace records the selected index (560), anchor selection (530), computed energy (580), seam configuration (820), mapping function settings (830), and any consistency metrics.

A fourth example embodiment derives a DNA structural period P0 from the DNA groove length scale and a self-similarity relation. In this embodiment, a cascade-derived DNA groove length output (580) is used as an input to compute a derived structural period P0 using a golden-ratio scaling relation. The derived period is computed as P0=X_DNA*phi\hat{ }2, where X_DNA denotes the derived DNA groove length scale obtained from the length cascade. Because phi is defined as the golden ratio, this relation produces a structural period that is self-similar under golden-ratio scaling. When reporting units are requested, the same calibration seam configuration applied to the groove length may be applied to P0 to provide a consistent reporting-unit result. The derivation trace records the groove length value used, the scaling relation applied, and the resulting period.

A fifth example embodiment derives the electromagnetic coupling constant or its inverse using the fine-structure derivation subflow illustrated in FIG. 9. In this embodiment, the target specification identifies a coupling parameter and the workflow selects an embodiment via the embodiment selector (910). In a functional-minimization embodiment, a coupling-dependent functional is defined as J_EM(alpha)=integral_0\hat{ }infty[((x/(x+alpha))\hat{ }2−(R_RP*eta_RP)\hat{ }2)\hat{ }2]dx (920). A seed value may be defined as alpha_seed=(R_RP\hat{ }2)*(eta_RP\hat{ }2)=49/1152 (930) and used as an initial guess or baseline for minimization.

A minimization procedure analogous to that used for J_cov is performed to obtain an alpha value that minimizes the functional, with numerical settings recorded in the derivation trace. In an alternate closed-form embodiment, an inverse coupling is computed as alpha_inv=4*pi*11−w8*ln(phi)+103/(102*pi\hat{ }5) (940), where w8 is an eight-tick projection weight and ln(phi) is the natural logarithm of phi (950), and where 103/(102*pi\hat{ }5) is a curvature/geometry correction term (960). The terms are combined as specified (970) to produce an output alpha_inv and, where needed, an alpha value derived from the inverse (980). When validation is enabled, the derived output is compared to a reference coupling value and a validation metric is computed (990), with a pass/fail/flag decision optionally recorded as part of the derivation trace. The embodiment selector (910) may be configured to execute one or both derivation pathways and to record the selected pathway(s) in the trace.

A sixth example embodiment derives a proton mass scale using an operator/spectrum pathway and/or a cascade pathway with mapping to mass. In an operator embodiment, an operator construct is formed (610) with a selected potential (620) and boundary/domain specification (630), and an eigenvalue solver computes spectral quantities (640). A selected spectral quantity is extracted (650) and mapped to an energy and then to a mass using m=E/c\hat{ }2 (660). In a cascade embodiment, an energy output is computed as E_n=E_anchor*(X_opt)\hat{ }n (520) for an index selected by a minimal overhead rule (540), and the energy is mapped to a mass using m=E/c\hat{ }2 (660). In certain embodiments, an RP modulation factor is applied (670) to reflect system-class recognition geometry; by way of example, a fermionic multiplicity or confinement class may be represented by a factor of eta_RP\hat{ }q and/or R_RP\hat{ }p for disclosed exponents. The derived mass scale is then optionally reported in a conventional mass unit via the calibration seam mapping of FIG. 8. The derivation trace records the operator or cascade pathway selected, the extracted spectral quantity or cascade index used, the mapping rule applied, and any modulation factor applied, together with any optional validation metric.

Alternative implementations and variations are disclosed to demonstrate that the derivation workflow is not limited to a single numerical routine, a single representation of a construct, or a single index-selection mechanism, and to provide prosecution-resilient embodiments that remain within the scope of the disclosed RS/RP constructs. In these variations, the underlying defining features are preserved: a target specification is mapped to an RS/RP system definition, a construct family is selected and instantiated using RS/RP-derived quantities, the construct is solved in a parameter-free manner, and the derived output is extracted using a disclosed extraction rule, with optional reporting through an explicitly declared calibration seam. Where numerical procedures differ, the differences are treated as computational controls and are captured in the derivation trace without introducing target-specific fitting.

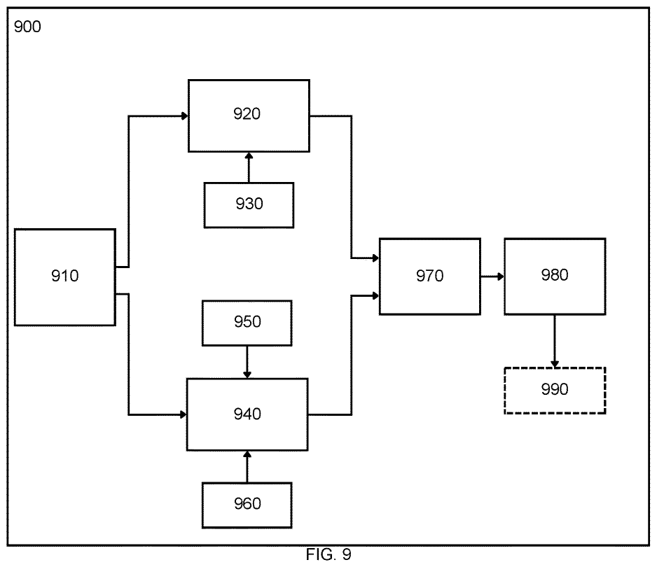

In certain variations of the cost-functional implementations illustrated in FIG. 4, the numeric integration and minimization procedures are implemented using different integration rules and different minimization routines while preserving the same functional definition. For example, evaluation of integral_0\hat{ }infty may be performed by truncating the domain to [0, x_max] using an integration window policy (470) and applying Simpson integration, Gaussian quadrature, adaptive quadrature, or other convergent numeric integration methods. Minimization may be performed using gradient-based methods, derivative-free methods, or hybrid methods, including a stationarity-based search for a root of dJ/dX=0 when analytic or numerical derivatives are available, or a direct minimization over a bounded interval when derivatives are not used. In such variations, the tolerance parameter (460), maximum iteration count, and convergence tests are selected to ensure numerical stability and reproducibility. In certain embodiments, convergence is verified by running the minimization at multiple values of x_max and confirming that the minimizer changes by less than a stated tolerance, and such convergence verification is recorded in the derivation trace (195) and may be included in the intermediate results record (760) as part of the derivation report format of FIG. 7.

In certain variations of the fine-structure derivations illustrated in FIG. 9, the embodiment selector (910) is configured to execute multiple derivation paths and treat the outputs as cross-checks rather than as competing results. For example, the functional-minimization path (920) may be executed to produce an alpha value, and the closed-form path (940) may be executed to produce an alpha_inv value, and the system may check consistency by comparing 1/alpha to alpha_inv under a defined tolerance. Where a divergence is detected, the optional validation block (990) may output a flagged result and record the discrepancy metric in the derivation trace.

This configuration enables a multi-path derivation trace in which the constants used list (740), solver settings (750), intermediate results (760), and final derived values (770) capture both pathways and a deterministic decision rule indicates whether the outputs satisfy internal consistency requirements.

In certain variations of the universal scale cascade implementations illustrated in FIG. 5, the cascade index selection (540) is implemented as a discrete scan, a continuous optimization, or a hybrid selection. In a discrete scan variation, candidate integer indices are evaluated within a finite range (for example, n_min to n_max) and a minimal overhead score is computed for each candidate, with the index that minimizes the score selected and recorded. In a continuous optimization variation, n is treated as a real-valued variable and a continuous objective is minimized to obtain a real-valued index, which may be used directly or rounded according to a disclosed rounding policy (for example, rounding to the nearest integer, rounding toward a stability interval, or rounding to satisfy a dimensionality constraint). In a hybrid variation, the continuous optimum is computed first and then a small neighborhood of integer indices around the continuous optimum is evaluated to select the discrete index with the minimal overhead score. These selection policies preserve the disclosed cascade formulas (510), (520) and treat the selection of n as an internal computation step rather than as empirical fitting.

In certain embodiments, the “overhead score” used for minimal-overhead index selection is computed for each candidate index n as:

$$Overhead ( n ) = wJ \cdot J ( \vert n - n 0 \vert + 1 ) + wC \cdot C\_fail ( n ) + wR \cdot R\_runtime ( n ) ,$$

where J(·) is a Recognition Science cost primitive, n0 is a system-class baseline index determined from the recognition geometry parameter(s) used in the system definition, C_fail(n) is a feasibility penalty (0 if all feasibility constraints are satisfied, otherwise a positive penalty), and R_runtime(n) is a normalized runtime or numerical-stability penalty computed from solver iterations and/or numerical condition indicators. Non-limiting feasibility constraints include: positivity of r_n and/or E_n; monotonicity over a local neighborhood of adjacent indices; numerical convergence of the solver within a maximum iteration limit; and bounded truncation error under an integration-window or discretization policy. If two candidate indices produce equal Overhead(n) within a tolerance ε_over, the system selects the index producing (i) a smaller truncation-error estimate and, if still tied, (ii) a smaller absolute index magnitude |n|. The candidate set may be an integer range [n_min, n_max] declared in solver settings and recorded in the derivation trace. In embodiments, the derivation trace records, for at least the selected index, the candidate-set bounds, the selected index value, and at least one overhead subcomponent value. The overhead score is computed without using any target-specific empirical value of the target constant or scale.

In certain variations, multi-cascade composition is used to model composite systems without adding new constructs beyond the disclosed cascade family. In such embodiments, a first cascade output is computed for a first index and a second cascade output is computed for a second index, and the composite target scale is computed from a disclosed composition rule such as a product, ratio, sum, or weighted combination, depending on the target type. For example, a composite length scale may be computed as r_comp=r_n1*(X_opt)\hat{ }delta for a disclosed integer or rational delta associated with a structural correction, or a composite energy scale may be computed as E_comp =E_n1+E_n2 where each term corresponds to a distinct recognition contribution. In these embodiments, the composition rule is explicitly disclosed and recorded in the derivation trace so that the composite output remains auditable and reproducible.

In certain variations of the operator and spectrum implementations illustrated in FIG. 6, the operator solver (640) and the representation of the operator may vary while preserving the operator construct definition, boundary/domain specification (630), and extraction rule (650).

For example, the operator may be discretized using finite differences, finite elements, or spectral basis expansions, and the eigenvalues may be computed using iterative eigensolvers, direct solvers, or stabilized Krylov methods. The basis size, resolution, truncation, and convergence tolerance are selected as numerical controls and captured in solver settings (750). In certain embodiments, multiple discretization resolutions are used to confirm convergence of the extracted spectral quantity, and the convergence record is captured in intermediate results (760) of the derivation report format (700).

In certain variations, the reporting layer illustrated in FIG. 8 is configured to support multiple reporting conventions while enforcing the no-target-specific-fitting constraint (850). For example, the declared anchor parameter(s) (820) may include a single-anchor seam configuration and an alternate Planck anchoring configuration, and the mapping function (830) may apply either configuration to the same RS-native outputs (810) to produce multiple reporting outputs (840) as part of a derivation trace. The optional consistency check (860) may then be used to verify that the reporting outputs remain internally consistent under RS/RP identities and that the reporting conversion has not introduced inconsistencies. In these embodiments, the seam configuration is recorded in the derivation trace so that reporting outputs are attributable to a declared mapping convention rather than to undisclosed per-target adjustments.

FIG. 8 depicts a reporting and calibration-seam pathway (800) in which RS-native outputs (810) are mapped to reporting outputs (840) using declared anchor parameter(s) (820) and a mapping function (830) while enforcing a no-target-specific-fitting constraint (850), and optionally performing a cross-output consistency check (860), with seam configuration and mapping settings recorded in the derivation trace to ensure that reporting-unit conversion is attributable to a declared convention rather than undisclosed per-target adjustment.

In certain variations, the derivation trace report format illustrated in FIG. 7 is extended to include additional metadata, while preserving the same core elements of target summary (710), construct selection (720), construct definition payload (730), constants used list (740), solver settings (750), intermediate results (760), final derived value (770), validation metrics (780), and decision rule output (790). For example, the derivation trace may include a trace hash, a timestamp, a software version identifier, and an execution environment identifier, enabling reproducibility across distributed compute environments (296) and supporting an audit log store (298). Such metadata variations do not change the derivation itself, but increase robustness by enabling reproducible reruns and by making it easier to detect changes in computational behavior across software or hardware configurations.

System and software implementation embodiments are provided to enable computation of the disclosed RS/RP derivations in an auditable, repeatable, and scalable manner when the independent claims recite computing artifacts. FIG. 2 illustrates a computing system implementing the derivation engine (200), including a user device or client (210) that provides a target constant or scale specification to the system, a network interface (220) that conveys such requests, and a derivation server or computing device (230) that executes the derivation workflow and returns derived outputs. The derivation server (230) is configured to execute a system definition module (240), a construct formulation module (250), a solver module (260), and an extraction module (270), and, in certain embodiments, an optional validation module (280) and a derivation trace generator (290). The system further includes a data store or database (292), an API endpoint or service interface (294), optional distributed compute resources such as a job queue or compute node pool (296), and an optional audit/log store (298). In operation, the computing system (200) receives a target specification from the client (210), performs parameter-free construct definition and solution on the derivation server (230), extracts a derived constant or scale, and returns the derived output together with a derivation trace, while optionally storing the derivation results for reuse, comparison, and auditability.

FIG. 2 depicts an example computing system architecture (200) including a client device (210) coupled via a network interface (220) to a derivation server or computing device (230) that executes a system definition module (240), construct formulation module (250), solver module (260), and extraction module (270), and optionally a validation module (280) and derivation trace generator (290), with outputs and trace artifacts stored in a data store (292) and/or audit/log store (298), optionally coordinated using distributed compute resources (296), and exposed through an API endpoint or service interface (294) to provide automated derivation with traceable computation artifacts.

The system definition module (240) receives or otherwise accesses a structured target specification that identifies a target constant or characteristic scale and sufficient metadata to select a construct family and instantiate an RS/RP system definition. In embodiments, the system definition module (240) parses the target specification to determine whether the target is dimensionless, a length, an energy, or a mass, and to determine recognition geometry parameters such as dimensionality d and a class/spin parameter s, together with a target tag indicating an interaction type or domain classification. The system definition module (240) thereby produces an internal system representation that constrains subsequent construct formulation and that identifies admissible construct options and constraints (for example, boundary/domain constraints for operator embodiments or permissible index families for cascade embodiments).

The system definition module (240) may also select, record, or validate a declared reporting preference identifying whether the derived output is to be provided in RS-native form or in a reporting unit through a calibration seam, while preserving the separation between parameter-free derivation and reporting-unit conversion.

The construct formulation module (250) instantiates a mathematical construct consistent with the system representation produced by the system definition module (240). In embodiments, the construct formulation module (250) selects among construct families including cost-functional constructs, operator/spectrum constructs, and scale cascade constructs, and parameterizes the selected construct using RS/RP constants and identities. For example, in cost-functional embodiments, the construct formulation module (250) instantiates an objective functional such as J_cov(X) or another disclosed functional, including any RS/RP self-similarity targets and the relevant RS/RP constants. In operator embodiments, the construct formulation module (250) instantiates an operator form such as H_hat together with a selected potential V(x) and disclosed boundary/domain specifications. In cascade embodiments, the construct formulation module (250) instantiates a length cascade r_n=L_anchor*(X_opt)\hat{ }n and/or an energy cascade E_n=E_anchor*(X_opt)\hat{ }n together with an index selection policy. In each case, the construct formulation module (250) selects the constants used (including X_opt, R_RP, eta_RP, phi, and pi where applicable) and records the construct definition in a form suitable for later inclusion in a derivation trace.

The solver module (260) computes a solution to the mathematical problem posed by the instantiated construct. In cost-functional embodiments, the solver module (260) computes an integral or aggregate cost value under a declared truncation policy and applies a minimization procedure to identify a minimizer of the functional. In operator embodiments, the solver module (260) discretizes the operator under the specified boundary/domain constraints and computes one or more eigenvalues or spectral invariants using an eigenvalue solver. In cascade embodiments, the solver module (260) computes cascade values for one or more indices and selects an index under a minimal overhead selection rule, including discrete scan embodiments and continuous-index embodiments. The solver module (260) maintains solver settings as computation controls, including tolerance thresholds, integration window parameters, discretization resolution, and iteration limits, and records these settings for reproducibility. The solver module (260) may execute computations locally on the derivation server (230) or, in embodiments requiring scaling, may dispatch computations to a job queue or distributed compute nodes (296) while preserving the same construct definitions and solver settings.

The extraction module (270) extracts a numerical value for the target constant or scale from the computed solution. In cost-functional embodiments, extraction includes reading the minimizing parameter value associated with the minimized functional. In operator embodiments, extraction includes reading a selected eigenvalue, eigenvalue spacing, or other spectral quantity and applying a disclosed mapping rule to obtain the target output type. In cascade embodiments, extraction includes reading the computed r_n or E_n value for the selected index and, where applicable, mapping an energy to a mass using m=E/c\hat{ }2 and applying any disclosed modulation factors. The extraction module (270) formats outputs in RS-native form and, when reporting in conventional units is requested, applies the declared calibration seam (as described elsewhere herein) to produce a reporting-units value. In embodiments, the extraction module (270) produces a structured output that includes the derived value, the construct family used, and sufficient metadata to reproduce the computation.

The derivation trace generator (290) creates a machine-readable trace/report artifact that captures the full derivation chain for auditability and reproducibility. In embodiments, the derivation trace includes the target identifier, the construct family selected, the full construct definition payload, the constants used, solver settings, intermediate results, and the final derived value. The derivation trace generator (290) may include a trace hash, timestamp, and software version identifier to support reproducibility across distributed compute resources (296) and to detect unintended changes in computational behavior. The derivation trace artifact may be stored in the database (292) and/or in the audit/log store (298), and may be returned to the client (210) as part of the response payload.

The validation module (280), when enabled, compares derived outputs to known references when such references are provided or available, computes a validation metric such as fractional deviation, and applies a decision rule such as pass/fail/flag based on a threshold. In embodiments, the validation module (280) does not modify the construct definition or solution to force agreement with a reference; rather, the validation module (280) performs a post-derivation evaluation and records the result. Validation metrics and decision outputs may be incorporated into the derivation trace generated by the trace generator (290) and stored in the database (292) and/or audit/log store (298), thereby providing an auditable record of performance without introducing target-specific fitting into the derivation itself.

In certain embodiments, the system is implemented as a software stack executed by the derivation server (230), including a Python implementation that uses NumPy for numerical computation, SciPy for numerical integration, differential equation solving, minimization, and eigenvalue computation, and SymPy for symbolic manipulation, derivative computation, or exact simplification where applicable. In certain embodiments, the system provides a REST API via the API endpoint or service interface (294), where an endpoint receives a target constant or scale description and returns a response including the derived value, a derivation pathway identifier, the derivation trace and/or intermediate data, and validation results if enabled. In certain embodiments, the database (292) stores a plurality of derivation entries, where each entry specifies a target name, a derivation pathway identifier corresponding to a construct family, a cascade index n when applicable, any modulation factors applied, a derived numerical value, solver settings, and a trace hash or timestamp, thereby enabling later retrieval, comparison, and audit of derived constants and scales. The audit/log store (298) may store additional reproducibility artifacts including raw solver logs, execution environment metadata, and versioned construct definitions, enabling the computing system (200) to satisfy the computing support requirements for the disclosed claims while preserving the parameter-free derivation posture of the RS/RP constructs.

Validation and verification embodiments are provided to support repeatable, auditable evaluation of derived outputs without converting the derivation itself into a fitting procedure. In these embodiments, validation is performed after a derived output has been computed from an RS/RP construct, and the validation procedure records the comparison results and any decision outcomes in a derivation trace artifact. FIG. 7 illustrates a derivation trace/report artifact (700) including a target summary (710), a construct selection identifier (720), a construct definition payload (730), a constants list (740), solver settings (750), intermediate results (760), a final derived value (770), validation metrics (780), and a pass/fail/flag decision output (790). The derivation trace artifact (700) enables reproducibility by preserving the exact construct form, constants used, and numerical computation controls that produced the derived output, and enables verification by preserving the quantitative basis for any validation outcomes.

FIG. 7 depicts an example derivation trace/report format (700) including a target summary (710), construct selection identifier (720), construct definition payload (730), constants used list (740), solver settings (750), intermediate results (760), final derived value (770), validation metrics (780), and a decision output (790), thereby providing an auditable record that enables independent recomputation of the derived value using the recorded construct definition and numerical controls without introducing target-specific fitting into the construct formulation or solution.

In reference-comparison embodiments, the derived output (770) is compared to a reference value when a reference exists and is available for the target. The reference value is not used to define the construct, is not used to tune parameters during construct formulation or solution, and is not used to select among candidate constructs in a manner that would constitute target-specific fitting. Instead, the reference comparison is applied as a post-derivation check that quantifies agreement (or disagreement) between the computed output (770) and an external reference. The derivation trace (700) records the reference identifier (for example, a data source label, standard dataset label, or publication identifier) and records the numerical reference value used for comparison as part of the intermediate results (760) and/or as part of the validation metrics (780), enabling later audit of which reference was used and how the comparison was computed.

In metric embodiments, one or more validation metrics (780) are computed to quantify error, deviation, or internal consistency. A primary metric in certain embodiments is fractional deviation, computed as fractional_deviation=abs(derived-reference)/reference, where derived is the derived output value (770) and reference is the corresponding reference value. Additional metrics may include absolute deviation in the reporting unit, ratio deviation for dimensionless targets, or normalized residuals where the target is derived from a set of related outputs. When no external reference is available for a target, internal consistency checks may be used as validation metrics (780), including dimensional-consistency checks, positivity checks for cascade outputs, monotonicity checks across adjacent cascade indices, identity checks across RS/RP relations when multiple derived outputs are produced from a shared RS-native basis, and cross-path agreement checks when the same target is derived using more than one disclosed embodiment.

Each validation metric (780) is recorded in the derivation trace (700) together with the inputs used to compute the metric, such that the metric can be recomputed independently from the recorded data.

In decision-rule embodiments, the system applies acceptance thresholds and outputs a decision (790) that classifies a derived output as accepted, flagged, or rejected for a given use case. The decision rule (790) may be based on one or more validation metrics (780). For example, a decision rule may specify a threshold epsilon and output “pass” when fractional_deviation<=epsilon, output “flag” when epsilon<fractional_deviation<=epsilon_flag, and output “fail” when fractional_deviation>epsilon_flag, where epsilon and epsilon_flag are predefined thresholds selected as computation policy values rather than as target-specific tuning parameters.

In internal-consistency embodiments, a decision rule may specify that a result passes if all required identity checks are satisfied within specified tolerances and if all required positivity and monotonicity conditions hold, and otherwise flags the result for review. In multi-path embodiments (for example, where a coupling is derived using two different disclosed approaches), a decision rule may compare the multiple outputs and output a flag when disagreement exceeds a threshold. The decision output (790) is recorded in the derivation trace (700) together with the thresholds and rule identifier applied, enabling later audit of why a given output was accepted or flagged. In this manner, validation and verification embodiments provide a robust, prosecution-supportive framework for documenting correctness checks and reproducibility without converting the derivation constructs into empirically tuned models.

The disclosed methods and systems provide parameter-free derivation of physical constants and characteristic scales using RS/RP constructs that are internally specified and auditable. A primary advantage is that a derived output is defined by a disclosed construct family and a disclosed extraction rule, rather than by target-specific empirical fitting. In particular, the workflow selects a construct family based on the target class, formulates the construct using RS/RP-derived quantities, solves the construct under numerical computation controls, and extracts the target value, while excluding insertion of empirically measured values specific to the target constant at the construct-definition and construct-solution stages. This structure supports prosecution by clearly distinguishing between derivation (which is internally defined) and post-derivation reporting or validation (which is performed without modifying the construct to force agreement).

Another advantage is that the disclosure provides multiple construct families that can be applied across multiple domains while maintaining a consistent derivation framework. Cost-functional embodiments enable derivation of optimal scales and couplings through minimization of explicitly defined functionals. Operator/spectrum and recognition-operator embodiments enable derivation of discrete or quasi-discrete outputs from invariant quantities of an operator construct, such as eigenvalues or stable recognition cycles. Universal scale cascade embodiments enable compact computation of characteristic length and energy scales from a universal scale factor and an index selected by a disclosed criterion. This multi-family structure supports robust claim coverage because multiple embodiments can support the same target type and because multiple targets can be derived using a shared RS/RP foundation.

A further advantage is that the disclosure provides explicit reproducibility and auditability through derivation trace artifacts. By recording the construct family selected, the construct definition payload, constants used, solver settings, intermediate results, and final derived value, the derivation trace enables reproducibility across computational environments and allows later verification without reconstructing or reinterpreting the derivation pathway. This traceability supports both technical reliability and prosecution robustness by providing a concrete record of what was computed and how it was computed, including the numerical computation controls used to ensure convergence.

The disclosed calibration seam provides an additional advantage by enabling reporting of derived outputs in conventional units while preserving the parameter-free nature of construct definition and solution. The calibration seam explicitly separates RS-native computation from reporting-unit mapping and enforces a no-target-specific-fitting constraint, reducing ambiguity regarding whether measured constants are being used as fit parameters. This explicit separation supports claim clarity and reduces the risk that “parameter-free” language is interpreted as indefinite, because the seam defines where and how reporting units are applied and how the seam is held constant across multiple targets.

The cascade embodiments provide additional advantages in the form of algebraic stability properties, including positivity guarantees for derived lengths and energies and monotonicity properties that can be used for internal validation and sanity checks. These properties support robust implementation by providing deterministic checks that can be applied even when external reference data is not available for a target scale. Similarly, the operator and spectrum embodiments provide a structured mechanism for generating discrete outputs from operator invariants, which can support derivations for target classes where discrete spectral structure is a natural computational representation.

The disclosed embodiments further support validation and verification without converting the derivation into a fitting process. By computing validation metrics as post-derivation outputs and recording pass/fail/flag decisions without modifying construct definitions or solver objectives to match reference data, the system supports objective evaluation of derived outputs while preserving the parameter-free derivation posture. This separation between derivation and validation can be beneficial in both technical use and patent prosecution contexts because it demonstrates that agreement with known values is not achieved by hidden tuning, but rather by applying RS/RP-defined constructs and then evaluating the results transparently.

The methods and systems disclosed herein are applicable in industrial and commercial settings that require computation, estimation, or cross-checking of physical constants, coupling parameters, characteristic scales, and derived quantities across multiple domains. The disclosed derivation engine provides a repeatable computational workflow for generating constants and scales from internally specified RS/RP constructs, producing auditable derivation traces, and optionally expressing derived outputs in conventional reporting units via an explicit calibration seam. These characteristics enable deployment as a software tool, a service, or an embedded module in larger computational pipelines where reproducibility, traceability, and consistent computation policy are operational requirements.

In metrology and standards-oriented applications, the disclosed derivation engine can be used as an independent computational cross-check for derived relationships among constants and scales, particularly where a user desires an auditable derivation trace that documents construct selection, constants used, solver settings, and the mapping from RS-native outputs to reporting units. In such settings, the derivation trace can serve as a reproducibility artifact for internal review, comparative analysis across reporting conventions, or sensitivity analysis with respect to computation controls such as tolerance and truncation policies. The explicit calibration seam can be configured as a system-level reporting convention to ensure consistent unit mapping across multiple targets without per-target tuning.

In computational physics, materials science, and simulation toolchains, the disclosed methods can be integrated as a parameter-free constant/scale generator to supply characteristic scales for modeling, initialization, normalization, or constraint checks. For example, a simulation platform can call the derivation engine to obtain a characteristic length or energy scale from a cascade embodiment, or to obtain a coupling representation from a cost-functional or closed-form embodiment, and then use the derived value as an internally consistent parameter in subsequent computations. The derivation trace enables an auditable record of how the value was generated, which can be useful in regulated or quality-controlled environments that require traceability of model inputs.

In computational chemistry and computational biology workflows, the scale cascade embodiments can be applied to generate characteristic structural scales and coherence-related energies associated with molecular or polymeric structures in embodiments where such scales are targets of interest. The ability to generate a derived scale and a corresponding trace can support downstream tasks such as parameter selection for molecular simulations, screening of candidate structural hypotheses, normalization of feature scales in analytical models, or consistency checks across multiple derived scales. Because the disclosed workflow includes optional validation and decision rules, such workflows can incorporate automated flagging when derived outputs fall outside specified thresholds relative to reference expectations or internal consistency checks.

In software-as-a-service deployments, the disclosed computing system embodiments support exposing the derivation engine as an API that receives a structured target specification and returns a derived value along with a derivation trace and optional validation metrics. Such a service can be used by enterprise research groups to generate derived constants and scales in a standardized way across multiple teams and projects, with consistent reporting conventions enforced via a centrally configured calibration seam. The database and audit/log store embodiments enable retention of derived results and derivation artifacts for later retrieval, comparison, regression testing, and reproducibility auditing, and the distributed compute embodiments support scaling to multiple concurrent derivations.

In data science and model-governance contexts, the derivation trace artifact can be used as a provenance record for derived constants and scales that are supplied to machine-learning or statistical models. For example, a pipeline may include a “constant/scale derivation” stage that is executed deterministically under recorded solver settings and recorded seam configuration, with outputs stored and versioned. This supports governance requirements where model inputs must be explainable and reproducible, and where changes in inputs due to software updates, tolerance updates, or seam changes must be detectable and auditable.

What is claimed is:

1. A computer-implemented method for deriving a physical constant or a characteristic scale, the method comprising:
receiving, by one or more processors, a target specification identifying a target physical constant or characteristic scale;
classifying the target specification as at least one of a dimensionless target, a length target, an energy target, or a mass target;
defining, based on the target specification, a recognition system representation that includes at least a recognition geometry parameter;
selecting, based on the classifying and the recognition system representation, a construct family from a plurality of construct families comprising (i) a cost-functional construct family, (ii) an operator or spectrum construct family, and (iii) a scale-cascade construct family;
instantiating a construct in the selected construct family using at least one Recognition Science or Recognition Physics (RS/RP) quantity and without using a target-specific empirical value of the target physical constant or characteristic scale;
solving the instantiated construct to produce a computed solution, wherein solving uses at least one numerical computation control selected from a convergence tolerance, an integration window parameter, a discretization resolution, an iteration limit, or an index search range;
extracting, from the computed solution, a derived value corresponding to the target physical constant or characteristic scale; and
generating a derivation trace artifact comprising a machine-readable record that records at least: (a) a target identifier and target class, (b) the selected construct family, (c) a construct definition payload including operative equations and any boundary or domain constraints invoked, (d) RS/RP quantities used, (e) solver settings including the at least one numerical computation control, (f) at least one intermediate value used for extraction, and (g) the derived value.

2. The method of claim 1, wherein selecting the construct family comprises selecting the cost-functional construct family, wherein the cost-functional construct family includes a coverage-based cost functional defined as J_cov(X)=integral_0\hat{ }infty[((x/(x+X))\hat{ }2−phi\hat{ }(−2))\hat{ }2]dx, and wherein extracting the derived value comprises extracting an X_opt corresponding to a minimizer of J_cov(X).

3. The method of claim 1, wherein selecting the construct family comprises selecting the scale-cascade construct family, wherein the scale-cascade construct family includes at least one of a length cascade r_n=L_anchor*(X_opt)\hat{ }n or an energy cascade E_n=E_anchor*(X_opt)\hat{ }n, and wherein extracting the derived value comprises computing a cascade output for an index n selected according to a minimal overhead selection criterion associated with the recognition system representation.

4. The method of claim 3, wherein the minimal overhead selection criterion comprises selecting the index n from a candidate set of indices by computing an overhead score for each candidate index and selecting the candidate index that minimizes the overhead score subject to at least one feasibility constraint, wherein the overhead score includes at least one of (i) a feasibility penalty that is non-zero when a convergence criterion is not met, or (ii) a numerical-stability or runtime penalty derived from solver iterations.

5. The method of claim 1, wherein selecting the construct family comprises selecting the operator or spectrum construct family, wherein the operator or spectrum construct family includes instantiating an operator H_hat and solving an eigenvalue equation to obtain one or more eigenvalues, and wherein extracting the derived value comprises extracting a spectral quantity from the one or more eigenvalues by applying an extraction rule that selects (i) a lowest eigenvalue, (ii) an eigenvalue spacing between successive eigenvalues, or (iii) an eigenvalue ratio, and recording the extraction rule in the derivation trace.

6. The method of claim 5, wherein extracting the derived value further comprises mapping an extracted energy to a mass using m=E/c\hat{ }2.

7. The method of claim 1, wherein generating the derivation trace further comprises recording at least one intermediate result selected from a minimizer value, a selected cascade index, an eigenvalue, or a mapped mass value.

8. The method of claim 1, further comprising applying a calibration seam after extracting the derived value to generate a reporting-units output, wherein the calibration seam comprises a declared mapping from RS-native quantities to reporting units, and wherein the declared mapping is applied without modifying the instantiated construct or the solving.

9. The method of claim 1, further comprising validating the derived value by:
computing an internal consistency metric by comparing (i) a first derived value produced using a first numerical computation control setting and (ii) a second derived value produced using a second numerical computation control setting that differs from the first numerical computation control setting;
computing a relative-change metric as |v2−v1|/max(|v1|, eps);
determining a pass/fail/flag decision by comparing the relative-change metric to a declared threshold; and
recording, in the derivation trace artifact, the internal consistency metric, the declared threshold, and the pass/fail/flag decision.

10. A computing system for deriving a physical constant or a characteristic scale, the computing system comprising:
one or more processors; and
one or more non-transitory memories storing instructions that, when executed by the one or more processors, cause the computing system to:
receive a target specification identifying a target physical constant or characteristic scale;
classify the target specification as at least one of a dimensionless target, a length target, an energy target, or a mass target;
define a recognition system representation that includes at least a recognition geometry parameter;
select a construct family from a plurality of construct families comprising (i) a cost-functional construct family, (ii) an operator or spectrum construct family, and (iii) a scale-cascade construct family;
instantiate a construct in the selected construct family using at least one RS/RP quantity and without using a target-specific empirical value of the target physical constant or characteristic scale;
solve the instantiated construct to produce a computed solution using at least one numerical computation control selected from a convergence tolerance, an integration window parameter, a discretization resolution, an iteration limit, or an index search range;
extract, from the computed solution, a derived value corresponding to the target physical constant or characteristic scale; and
generate and store a derivation trace artifact comprising a machine-readable record that records at least: (a) a target identifier and target class, (b) the selected construct family, (c) a construct definition payload including operative equations and any boundary or domain constraints invoked, (d) RS/RP quantities used, (e) solver settings including the at least one numerical computation control, (f) at least one intermediate value used for extraction, and (g) the derived value.

11. The computing system of claim 10, wherein the instructions further cause the computing system to provide a service interface that receives the target specification via a network and returns a response comprising the derived value and the derivation trace.

12. The computing system of claim 10, wherein the instructions further cause the computing system to store, in a database, a plurality of derivation entries, each derivation entry comprising at least a target identifier, a construct-family identifier, solver settings, and a trace identifier.

13. The computing system of claim 10, wherein the instructions further cause the computing system to enforce a no-target-specific-fitting constraint by preventing per-target modification of a calibration seam configuration stored as a system-level configuration.

14. The computing system of claim 10, wherein the instructions further cause the computing system to solve the instantiated construct using at least one numerical computation control selected from an integration window parameter, a convergence tolerance, a discretization resolution, or an iteration limit, and to record the at least one numerical computation control in the derivation trace.

15. The computing system of claim 10, wherein the instructions further cause the computing system to compute, as the derived value, an electromagnetic coupling value or an inverse coupling value using at least one of (i) a cost-functional minimization embodiment or (ii) a closed-form embodiment that includes a term ln(phi).

16. A non-transitory computer-readable medium storing instructions that, when executed by one or more processors, cause the one or more processors to perform operations comprising:
receiving a target specification identifying a target physical constant or characteristic scale;
classifying the target specification as at least one of a dimensionless target, a length target, an energy target, or a mass target;
defining a recognition system representation that includes at least a recognition geometry parameter;
selecting, based on the classifying and the recognition system representation, a construct family from a plurality of construct families comprising (i) a cost-functional construct family, (ii) an operator or spectrum construct family, and (iii) a scale-cascade construct family;
instantiating a construct in the selected construct family using at least one RS/RP quantity and without using a target-specific empirical value of the target physical constant or characteristic scale;
solving the instantiated construct to produce a computed solution using at least one numerical computation control selected from a convergence tolerance, an integration window parameter, a discretization resolution, an iteration limit, or an index search range;
extracting, from the computed solution, a derived value corresponding to the target physical constant or characteristic scale; and
generating a derivation trace artifact comprising a machine-readable record that records at least: (a) a target identifier and target class, (b) the selected construct family, (c) a construct definition payload including operative equations and any boundary or domain constraints invoked, (d) RS/RP quantities used, (e) solver settings including the at least one numerical computation control, (f) at least one intermediate value used for extraction, and (g) the derived value.

17. The non-transitory computer-readable medium of claim 16, wherein the operations further comprise applying a calibration seam to produce a reporting-units output, the calibration seam comprising at least one declared anchor parameter and a mapping function that maps RS-native quantities to the reporting-units output.

18. The non-transitory computer-readable medium of claim 16, wherein the operations further comprise selecting the construct family by selecting the cost-functional construct family for the dimensionless target and selecting the scale-cascade construct family for the length target.

19. The non-transitory computer-readable medium of claim 16, wherein the operations further comprise selecting, for the scale-cascade construct family, an index n by scanning a finite index range and selecting an index that minimizes an overhead score, and computing at least one of a derived length r_n or a derived energy E_n using (X_opt)\hat{ }n.

20. The non-transitory computer-readable medium of claim 16, wherein the operations further comprise performing a cross-output consistency check by comparing at least two derived outputs produced under a shared calibration seam configuration and recording a result of the cross-output consistency check in the derivation trace.
